(19) United States
(12) Patent Application Publication
(10) Pub. No.: US 2009/0012933 A1
(43) Pub. Date: Jan. 8, 2009

(54) System that allows law enforcement agencies or other users to be made aware of individuals with criminal records who have relocated into their jurisdiction or area.

(75) Inventor: Salvatore Verini, JR., Coral Springs, FL (US)

Correspondence Address: Salvatore Verini, Jr., 9642 NW 28th Place, Coral Springs, FL, 33065, US

(73) Assignee: Salvatore Verini, JR., Coral Springs, FL (US)

(21) Appl. No.: 11/772,266

(22) Filed: Jul. 2, 2007

(51) Int. Cl. G06F 17/30

(52) U.S. Cl. 707/3; 707/104.1; 707/E17.014

(57) ABSTRACT

A system and method that allows law enforcement agencies or other users to be made aware of those with criminal records who have relocated into their jurisdiction or area. The system and method is done by comparing individuals that have a criminal record against lists of individuals who have moved/relocated from one residence to another.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

A problem that has plagued law enforcement agencies in the past has been the lack of data or information pertaining to the residential relocation of individuals who have been charged with criminal activity. Another has been the issue of having to solve a crime when no leads are available. This system and method of tracking those with criminal records, who have relocated their residence into a law enforcement agency's jurisdiction, will increase that awareness as well as potentially generate leads for crimes that have already occurred.

### BRIEF SUMMARY OF THE INVENTION

This is a system and method accessible via the Internet (World Wide Web) that allows law enforcement agencies or other users to be made aware of those with criminal records who have relocated into their jurisdiction or area. The system and method is performed by comparing individuals that have criminal records against lists of individuals who have moved/relocated from one residence to another. This is primarily performed by cross-referencing a commercially available or custom-compiled national criminal records database containing those individuals with criminal records against a commercially available or custom-compiled national residential “new mover” database. Those new movers, if after obtaining an initial match against the criminal records database, are marked for export to a separate database.

Matching is based on full name and date of birth, however may also be matched upon by social security number or other uniquely identifiable number such as driver's license number. The new mover's full name, address, date of birth (or social security number or driver's license number or all available identifiers) along with the criminal charge and person's move/relocation date, are imported into a production database that is searchable by users. Search and filter functions can include searching by move/relocation date range, specific criminal charge and/or both as well as basing it on the mover's new physical address.

Results of said query can be displayed within a client's web browser on their computer. Displayed results may be in text form or graphical in the form of a mapping software's graphical street map display (mashup), and/or both and can plot the position of the new mover with the criminal record within client's jurisdiction based on the new mover's address via latitude/longitude coordinates.

### DETAILED DESCRIPTION OF THE INVENTION

### Introduction

This is a system and method accessible via the Internet (Word Wide Web) that allows law enforcement agencies or other users to be made aware of those with criminal records who have relocated into their jurisdiction or area. The system and method is done by comparing individuals that have been criminally convicted or charged against lists of individuals who have moved/relocated from one residence to another. This is primarily performed by cross-referencing a commercially available or custom-compiled national criminal records database containing those individuals with criminal records against a commercially available or custom-compiled national residential “new mover” database.

### User Interface

Once a client user has a username and password issued to them, they may log into the web service via usage of the Internet (World Wide Web), that resides on a website hosted on a server or cluster of servers. Once logged in, user is presented with an interface that allows queries to be issued to the database. Queries are for finding the new movers to the area of jurisdiction. The interface gives the option of filtering the results in order to not be overwhelmed with the number of returns, which may be typical in large metropolitan cities or when searching by entire county or state. Filtering options include, but are not limited to, filtering by state, county, city and by zip code. Further filtering is provided by giving the user the opportunity to pick a date range, which will further filter the results, by only displaying those individuals that moved into client's jurisdiction within the user-defined date range. User can further filter the results by criminal charge-type if desired.

After query and filtering are complete, the matching results are displayed. Display options are text or graphical as both options are available and the user can pick which display they prefer. Text display contains the individuals who match the query/filtering process in a text-form with each individual's name containing a hyperlink. Hyperlink, when selected, will run the individual's entire criminal record and address history. Criminal records and address histories are provided from databases that are also residing on servers. These databases may be commercially purchased or custom-compiled. If the graphical display is picked, results will display embedded into a graphical map display/mashup of user's area and/or jurisdiction. Mapping software can be third-party or proprietary and the addresses of the individuals that match the user query/filtering will be displayed as highlights upon the map (highlight may include, but not limited to graphical icons such as arrows, exclamation points, etc) that mark the residence of the individual as provided by latitude/longitude coordinates associated with the address of each person returned in the query. User may then select the associated highlight for each person displayed to then obtain the full criminal record and address history as also provided via the text display option.

### User Administration

Those deemed Administrators will have the ability to manage other users within their organization. The administrator of the organization's account will be able to activate/deactivate other users associated with the account. Each account administrator will have the ability to add or remove users at their discretion. Administrator will be able to input new user's name and other information relating to new user, as well as issue username and password to the new user.

### Compiling, Processing and Manipulation the Raw Data

System will consist of separate databases residing on a server or server cluster. For representational purposes, three separate databases will be mentioned within this section and respectively referred to as Database 1, Database 2 and Database 3. Database 1 will be a temporary database whereas data for new residential movers is initially imported into. Data imported should consist of movers' full name, new address, move date and date of birth for matching and merge purposes. Database 2 is a static database that contains criminal records that are commercially available or that are custom compiled. Database 3 is a production database whereas all merged data from Database 1 and Database 2 reside in.

After importing raw data consisting of new mover's full name, address, move date and date of birth, a server-side merge process will be run comparing entries in Database 1 against entries in Database 2, which will match upon mover's name and date of birth. When a name/date of birth match is found, all information pertaining to matched upon person in Database 1 and criminal record information pertaining to matched upon person in Database 2, will be merged together to from a single entry and imported into Database 3. NOTE: when specification is referring to the name and date of birth matching criteria, it should also be noted that using a supplemental matching criteria such as Social Security Number and Driver's License Number may also be used depending on the source data's contents. All reference to the “Name and Date of Birth” matching within specification shall include all possible matching criteria and combinations.

### Query/Filtering Process

Users may query and/or filter a query against Database 3, hereafter referred to as “production database”, by date range of move, location of move or by criminal charge. This is performed by a server-side filtering process whereas data within production database is queried upon.

Filtering by location can be performed by comparing the query with the addresses within production database. Location matching criteria is based off the address, city, state and zip code of individuals residing in production database after merge process. By specifying a location, only criminal movers that have relocated within specified location (state, county, city, zip code) will be displayed.

When querying/matching with a date range applied to query, results are determined by the move dates that are associated with the individuals residing in production database after merge process. By specifying a date range, only criminal movers that have relocated within specified date range will be displayed.

When applying a filter for criminal charge, results are determined by the criminal record associated with the person's residing within production database after merge process. By specifying a criminal charge, only criminal movers that have relocated that have been charged with chosen criminal charge will be displayed.

Any and all combinations of querying/filtering may be used by user if desired to narrow down the possible results

### BRIEF DESCRIPTION OF THE SEVERAL VIEWS OF THE DRAWINGS

FIG. 1 is a flow chart representing the method and system to access the user interface via web-based login to a server via the World Wide Web and the user's interaction navigating from the user login screen to the user interface main area.

FIG. 2A is a flow chart representing the user's interaction with the user interface.

FIG. 2B is a flow chart representing the user's interaction for conducting a search for criminal movers within their jurisdiction.

FIG. 3 is a flow chart representing the user's interaction in regards to querying address history and criminal record of chosen individual from a search response after searching/filtering as referred to in FIG. 2A and FIG. 2B.

FIG. 4 is a flow chart representing the User Administration area's methods and system.

FIG. 5 is a flowchart representing the method and system of the compiling, processing and manipulation the raw data to be used within the system.

### DETAILED DESCRIPTION OF THE SEVERAL VIEWS OF THE DRAWINGS

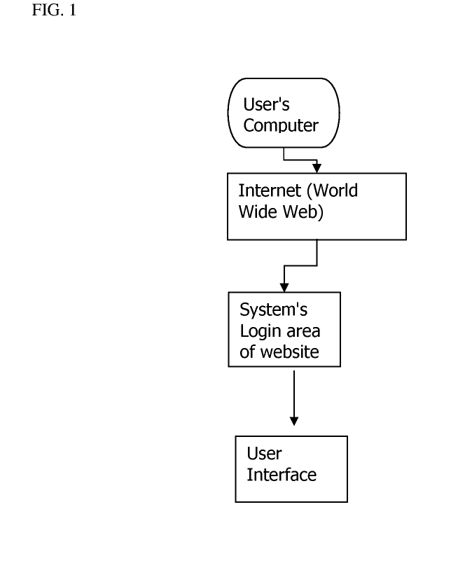

FIG. 1—This flow chart represents the method and system a client uses to access the system. User, via the Internet (World Wide Web), navigates to the login page of said system. There user enters a unique username and password combination to gain entry to the web service's User Interface's landing page.

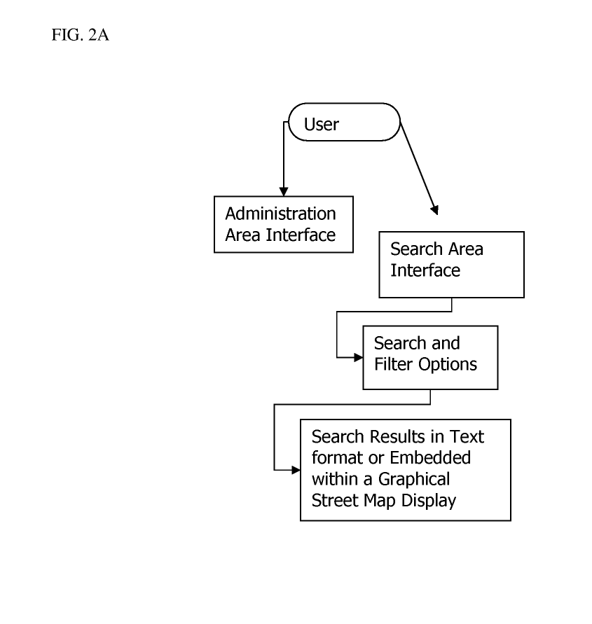

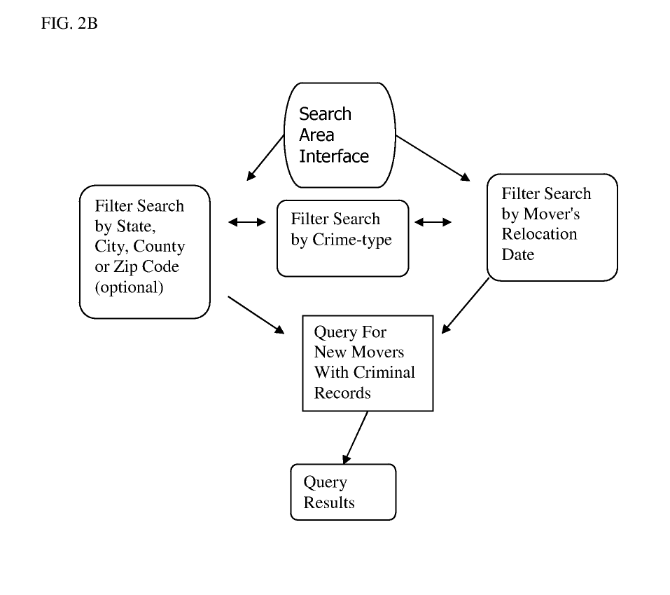

FIG. 2A—This flowchart represents what the user is presented with once viewing the User Interface. This includes search and filtering options, options for the displaying of the results and User Administration area. User may also choose between results in a text format or results embedded within a graphical street map view.

FIG. 2B—This flowchart represents the user's interaction for conducting a search for the criminals that moved into their jurisdiction or area. Users have the option to perform a search query by city, county or by state. User may further refine the query by zip code as well. User may also further narrow the results of the search by crime-type by only displaying individuals that were convicted of certain crimes (ex. burglary, robbery, sex offenders, etc.) or no preference of crime by choosing to view all results. User can further narrow down the initial results by picking a date range. By specifying a date range, only criminal movers that have relocated within specified date range will be displayed.

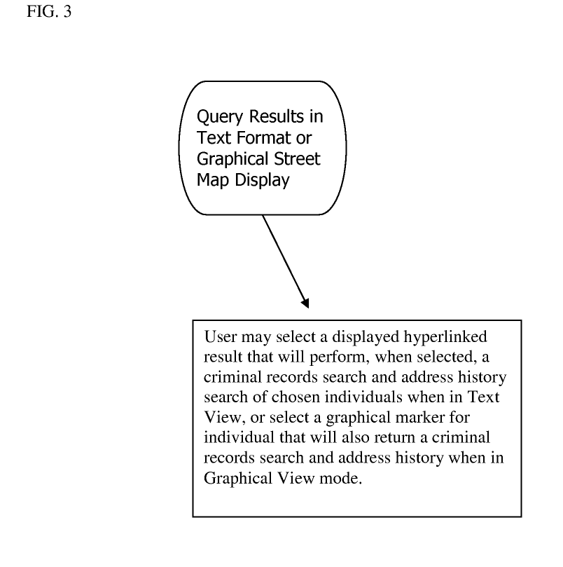

FIG. 3—This flowchart represents the user's interaction with results, regardless if in text view or graphical map view. Here user will be able to select displayed individuals of their choice to view address history and criminal records of said individuals. This additional data is provided by a third-party or proprietary databases.

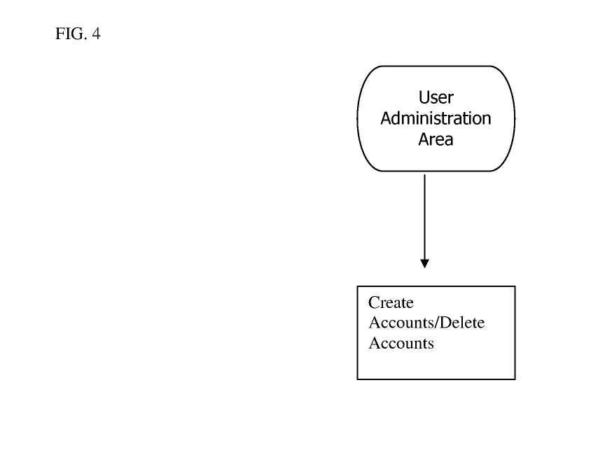

FIG. 4—This flowchart represents the administrative user's interaction within the Administration area. Here administrator/user will be able to create and delete sub-accounts associated with the main account.

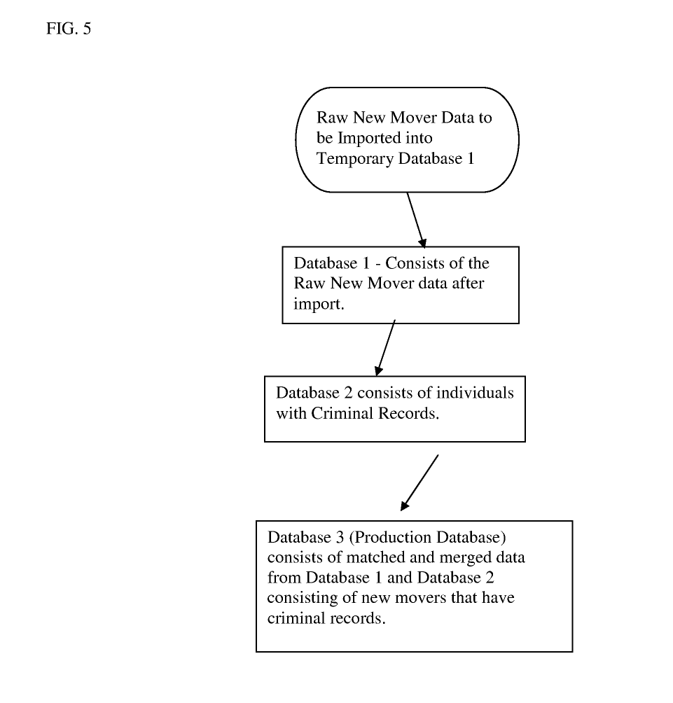

FIG. 5—This flowchart represents the merge process that occurs between the temporary database of residential movers, the static database consisting of individuals with criminal records, and the production database that is searchable by users.

I claim:

1. This system and method will allow law enforcement agencies or other users to be made aware of individuals with criminal records who have relocated into their jurisdiction or area. This system and method will be accessible to end users via the Internet (World Wide Web) and will reside on a server or server cluster.

2. This system and method, as in claim 1, is performed by comparing individuals that have criminal records against lists of individuals who have moved/relocated from one residence to another.

3. This system and method, as in claim 2, in order to determine if a mover has a criminal record, uses commercially available or custom-compiled “new mover” lists or other lists of those individuals who relocated their residence. These new movers are first imported into a temporary database. Those individuals in the temporary database are then cross-referenced against a database of individuals with criminal records by name and date of birth (or using other uniquely identifiable information). The criminal record database is also commercially available or custom-compiled. If a match is made, all information pertaining to matched upon individual from the temporary database (full name, address, date of birth, move date, etc) and all information from the criminal records database pertaining to same matched upon individual (criminal charge, disposition, etc), are copied over and imported into a production database that is searchable by users.

4. This system and method, as in claim 3, further comprises that it allows users to search for new movers with criminal records by state, county, city and by zip code. User may further narrow results by filtering by criminal charge. Only movers with specific charges will be displayed with this option. User may also further narrow results by choosing a date range. By specifying a date range, only criminal movers that have relocated within specified date range will be displayed.

5. User has the option to view results in text format or graphical format.

6. In regards to claim 5, results in text format will contain hyperlinks to further gather more information on selected individual. Further information can include, but not limited to, complete address history and criminal records of chosen individual. Results in graphical format will be displayed embedded into a graphical street map with graphical markers specifying the location of each individual within the results set. Marker locations are determined by latitude/longitude coordinates of returned addresses. Further information on chosen individual can be displayed by selecting the graphical marker. Further information can include, but not limited to, complete address history and criminal record of chosen individual.

7. This system and method will also contain a user Administration area. Those deemed Administrators will have the ability to manage other users within their organization by creating/deleting usernames and passwords and other account management needs.
